(19) United States
(12) Patent Application Publication
(10) Pub. No.: US 2005/0221831 A1
(43) Pub. Date: Oct. 6, 2005

(54) Routing area selection for a communication device accessing a network through a secondary communication network

(76) Inventors: Mark E. Pecen, Palatine, IL (US); Niels Peter Skov Andersen, Roskilde (DK); Sanjay Gupta, Lakewood, IL (US); Ravi Kuchibhotla, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 10/813,812

(22) Filed: Mar. 31, 2004

(51) Int. Cl. H04B 3/36; H04Q 7/20; H04B 7/14

(52) U.S. Cl. 455/445; 455/422.1

(57) ABSTRACT

A method (400) and apparatus (600) for selecting a routing area for establishing communication between a primary communication network (102) having a primary routing area (104) and a communication device (122) having a primary identification and supporting a cellular core network signaling protocol of the primary communication network (102) through a secondary communication network (112) are disclosed. The communication system (100) creates (404) a plurality of secondary routing areas (108, 110), each of which has at least one of a plurality of secondary communication networks (112, 114, 116, 118 120). Each secondary communication network is capable of providing a communication coverage for the communication device (122). The presence of the communication device (122) is detected (412) through a particular secondary communication network (112), and a target routing area (108) is determined (414). Services, originally directed to the primary identification of the communication device (122), is then re-directed (416) to the target routing area (108).

### FIELD OF THE INVENTION

The present invention generally relates to routing area selections, and more specifically to a method and an apparatus for selecting a proper routing area for a communication device accessing a communication network through a secondary communication network.

### BACKGROUND OF THE INVENTION

When a cellular wireless mobile communication device is first switched on, its receiver scans an allocated radio frequency (“RF”) spectrum for appropriate signals from base stations in a network that may provide service. Once the cellular wireless mobile communication device has identified and synchronized to a group of base stations, it ranks RF characteristics associated with each of the identified base stations in order of filtered signal strength. The cellular wireless mobile communication device then selects the base station having the strongest filtered signal strength on which to “camp.” Camping on a base station refers to the reading of broadcast information for monitoring paging messages that alert the cellular wireless mobile communication device of an incoming call. Once the cellular wireless mobile communication device camps on a base station, a signaling sequence, referred to as a routing area (“RA”) update, is exchanged between the network and cellular wireless mobile communication device. The RA update informs the network of a subgroup of base stations available in a RA which include the base station on which the cellular wireless mobile communication device is camping. The RA update assists the network in determining how to reach the cellular wireless mobile communication device. For example, when a subscriber number is called, the network must determine how a mobile switching centre (“MSC”) routes a paging message to the cellular wireless mobile communication device.

In a typical cellular system, the cellular wireless mobile communication device does not provide the network with its location information, such as a cell identifier, every time it selects a new cell. Because the radio wave propagation is highly sensitive to changes in the physical environment even in an environment where the RF coverage is very good, cell reselection occurs frequently. Therefore, if the cellular wireless mobile communication device were to inform the network for every cell reselection, signaling between the cellular wireless mobile communication device and network would likely congest the control channels. Further, because signaling messages deliver no revenue to the operator of the network, signaling messages are maintained at a level that is as infrequent as practical. When the MSC receives a call from an outside party who desires to reach the cellular wireless mobile communication device, or its user, the MSC looks up the logical location of the cellular wireless mobile communication device indicated by the RA, and sends a paging message only to a base station controller (“BSC”) in the RA. The BSC then sends paging messages on control channels only to the base station identified in the RA. The cellular wireless mobile communication device then receives the paging message and alerts the user of the incoming call.

Generally, the cellular wireless mobile communication device acts autonomously and simply listens to the broadcast control channels (“BCCH”), which include paging messages, of each cell. However, to provide the location information of the cellular wireless mobile communication device as it travels through the network, the cellular wireless mobile communication device sends an RA update message to the network whenever the cellular wireless mobile communication device crosses an RA boundary. This RA update procedure includes an authentication procedure to verify the cellular wireless mobile communication device as a valid subscriber. If the cellular wireless mobile communication device fails to send a RA update as it leaves one RA and enters into another, the network would send pages to the previous RA, and the cellular wireless mobile communication device would miss incoming calls. If the network fails to receive an RA update from the cellular wireless mobile communication device for some time, such as several hours to several days, the network will detach the cellular wireless mobile communication device from the network. The network may send to voice-mail any received calls for the cellular wireless mobile communication device after detaching. Most cellular systems have a periodic timer that causes the cellular wireless mobile communication device to perform the RA update at a predetermined time interval such as every two hours. An RA update procedure is additionally used when a cellular wireless mobile communication device changes its operating systems, or radio access technology, such as a change between a Global System for Mobile Telecommunication (“GSM”) system and a Universal Mobile Telecommunication Service (“UMTS”) system. The RA update is also performed when the cellular wireless mobile communication device returns to its idle mode from certain communication services such as Dual Transfer Mode (“DTM”).

### BRIEF DESCRIPTION OF THE DRAWINGS

FIG. 1 is an exemplary block diagram of an embodiment of a communication system in accordance with the present invention;

FIG. 2 is an exemplary block diagram of a variation of an embodiment of a communication system in accordance with the present invention;

FIG. 3 is an exemplary block diagram of another variation of an embodiment of a communication system in accordance with the present invention;

FIG. 4 is an exemplary flowchart illustrating a method in a communication system for selecting a routing area for establishing communication between a primary communication system and a communication device in accordance with the present invention;

FIG. 5 is an exemplary flowchart illustrating an alternative process of determining a target routing area and re-directing the services to the target routing area; and

FIG. 6 is an exemplary block diagram of an embodiment in accordance with the present invention of a communication system configured to select an appropriate routing area.

### DETAILED DESCRIPTION OF THE PREFERRED EMBODIMENTS

The present invention generally provides a method and apparatus for a communication system for selecting an appropriate routing area for establishing communication between a primary communication network and a communication device to through a secondary communication network. The primary communication network, having a primary routing area, may typically be a cellular communication network such as, but not limited to, Third Generation (“3G”), Global System for Mobile Communications (“GSM”), or Code Division Multiple Access (“CDMA”); the communication device may be a cellular mobile communication device compatible with the primary communication system or a communication device supporting a cellular core network signaling protocol of the primary communication network; and the secondary communication network, having a secondary routing area, may be an unlicensed communication network such as, but not limited to, a wireless local area network (“WLAN”), which is less expensive to operate than a licensed cellular band and is capable of supporting a wideband data transfer. The communication system detects the presence of the communication device in a secondary routing area, determines a target secondary routing area in which the communication device is currently located, re-directs services to the target routing area, and pages the communication device in the target routing area.

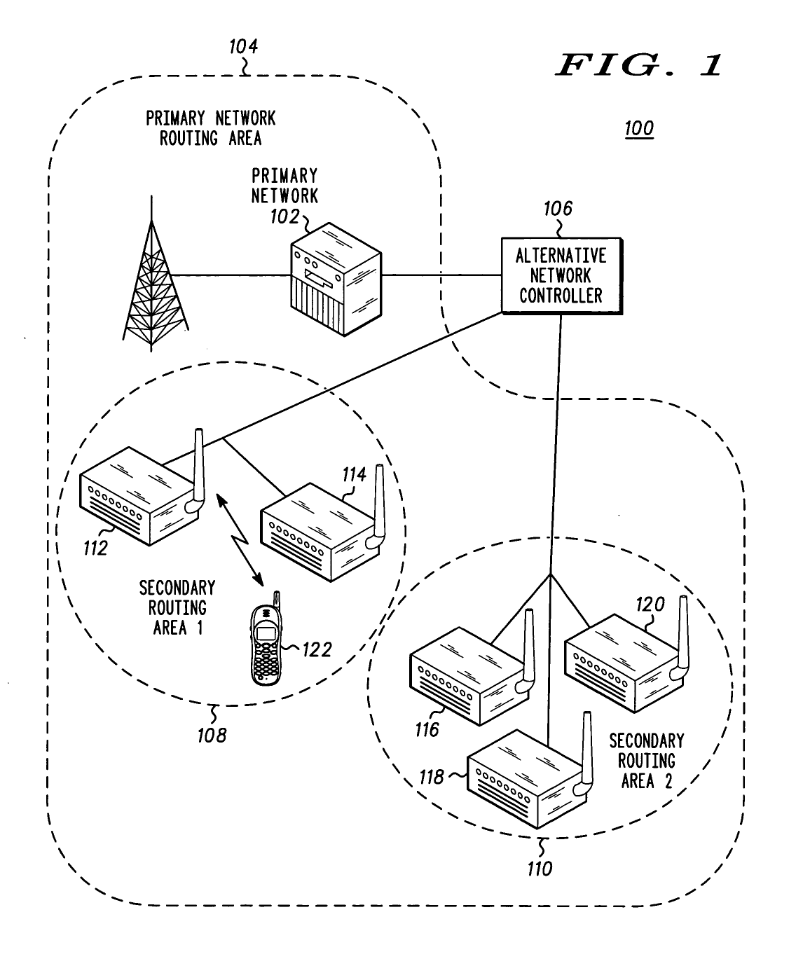

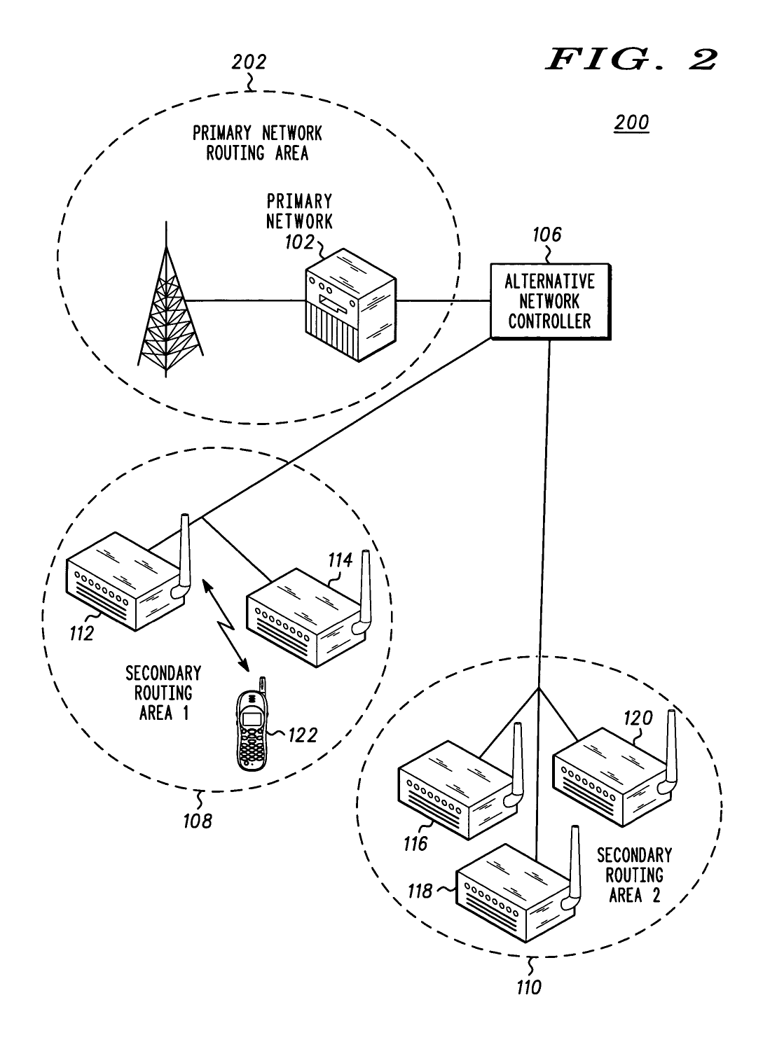

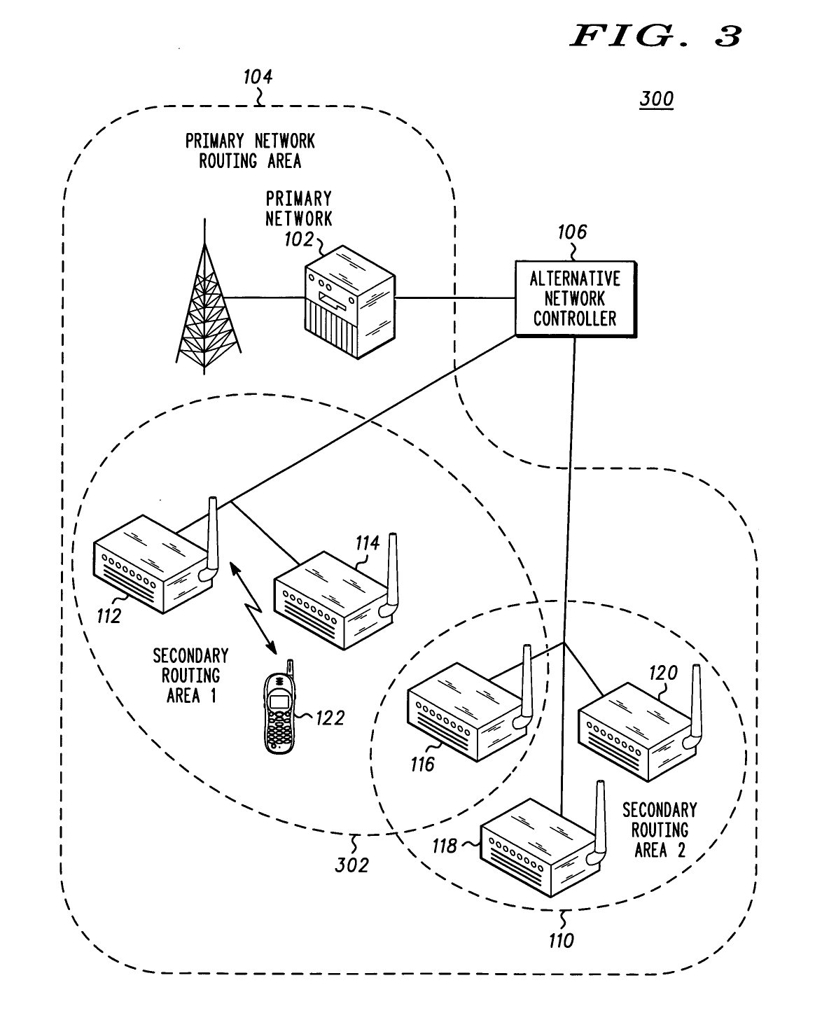

FIG. 1 is an exemplary block diagram of an embodiment of a communication system in accordance with the present invention. The communication system 100 comprises a primary communication network 102, which is illustrated as a cellular network. The primary communication network 102 has a primary routing area 104, and is coupled to an alternative network controller 106. The alternative network controller 106 is coupled to a plurality of secondary routing areas (only two secondary routing areas 108 and 110 are shown). Each of the plurality of secondary routing areas comprises at least one secondary communication network. In FIG. 1, the first secondary routing area 108 is illustrated with two secondary communication networks 112 and 114. The second secondary routing area 110 is illustrated with three secondary communication networks 116, 118, and 120. A communication device 120 is illustrated as wirelessly communicating with the secondary communication network 112 in the first secondary routing area 108. The second communication network 106 may be one of many types of networks such as, but not limited to, an unlicensed communication network, a local area network (“LAN”), a wireless local area network (“WLAN”), a wideband network, an infrared network, and a short-range network. In FIG. 1, the primary network routing area 104 is illustrated as covering the secondary routing areas 108 and 110, however, other routing area configurations are possible. For example, as shown in FIG. 2, the primary routing area 202 may not overlap any secondary routing areas. FIG. 3 another example where the secondary routing areas 110 and 302 overlap each other, and share one of the secondary communication network 116, while the primary routing area 104 covers both secondary routing areas 110 and 302.

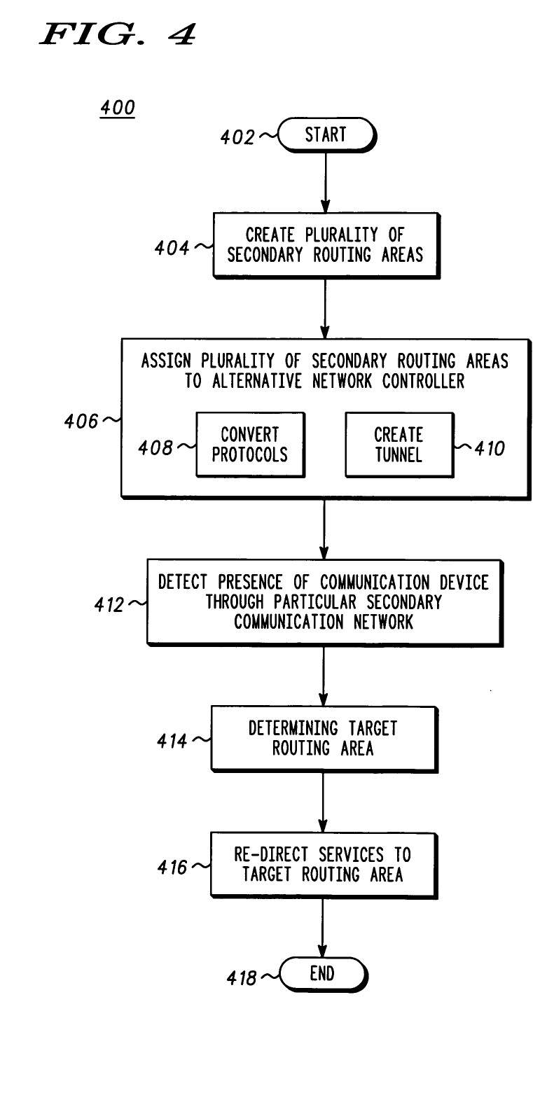

FIG. 4 is an exemplary flowchart 400 illustrating a method in a communication system 100 for selecting a routing area for establishing communication between a primary communication system 102 and a communication device 122 in accordance with the present invention. The primary communication network 102 operates using a cellular core network signaling protocol. The communication device 122 supports the cellular core network signaling protocol of the primary communication network 102 and has a primary identification such as an assigned telephone number, which is generally used to establish communication with the primary communication network 102. The process begins in block 402, and in block 404, the primary communication system 102 creates a plurality of secondary routing areas, such as the first and second secondary routing areas 108 and 110 shown in FIG. 1. Each of the plurality of secondary routing areas has at least one secondary communication network. For example, as shown in FIG. 1, the first secondary routing area 108 has two secondary communication networks 112 and 114, and the second secondary routing area 110 has three secondary communication networks 116, 118, and 120. Each secondary communication network is capable of providing a communication coverage for the communication device 122. In block 406, the plurality of secondary routing areas, the first and second secondary routing areas 108 and 110 in this example, are assigned to the alternative network controller 106.

The alternative network controller 106 is capable establishing communication between the primary communication network 102 and the communication device 122. As shown in block 408 within block 406, the alternative network controller 106 may establish communication by converting a protocol of the secondary communication network 112 into the cellular core network signaling protocol of the primary communication network 102, and converting the cellular core network signaling protocol of the primary communication network 102 into the protocol of the secondary communication network 112. As also shown in block 410, the alternative network controller 106 may also establish communication by creating and controlling a tunnel, which is an extra protocol addressing layer used to carry data, between the communication device 122 and the alternative network controller 106.

In block 412, a particular secondary communication network detects a presence of the communication device 122. In FIG. 1, the particular secondary communication network is shown to be the secondary communication network 112 in communication with the communication device 122 in the first secondary routing area 108. The presence of the communication device 122 may be detected by the particular secondary communication network 112 upon receiving a request from the communication device 122 to access the particular secondary communication network 112. The particular secondary communication network 112 may then assign a secondary identification to the communication device 122 in response to receiving the request, and further author the communication device 122 to access the particular secondary communication network 112.

In block 414, a target routing area, which is a secondary routing area that has the particular secondary communication network, is determined. In this example, the target routing area is the first secondary routing area 108, which has the particular secondary communication network 112. The alternative network controller 106 or by the primary communication network 102 may determine the target routing area. For example, a secondary routing area identification of the target routing area 108 may be received by either the alternative network controller 106 or by the primary communication network 102 by the primary communication network. In block 416, the primary communication network 102 re-directs services originally directed to the primary identification of the communication device 122 to the target routing area 108. The primary communication network 102 associates the primary identification of the communication device 122 with the secondary identification of the communication device 122 received in block 412 such that the re-directed services can be properly received by the communication device 122. The alternative network controller 106 may also identify available secondary communication networks 112 and 114 associated with the target routing area 108, and causing the available secondary communication networks 112 and 114 to page the communication device 122. The process then terminates in block 418.

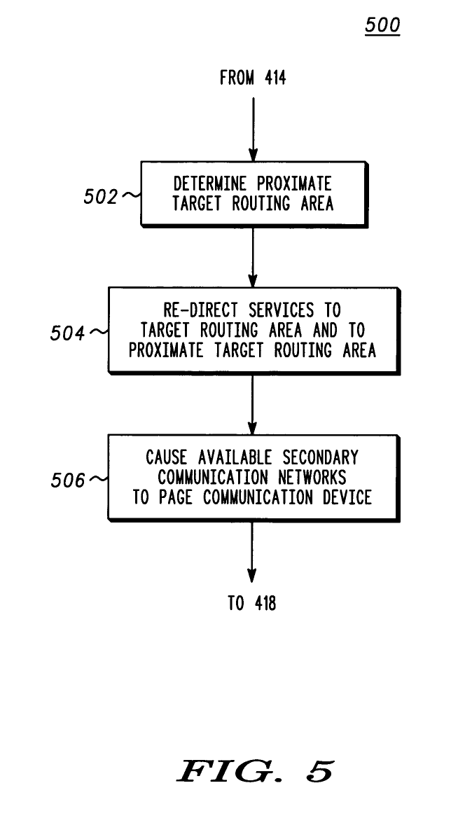

FIG. 5 is an exemplary flowchart further illustrating an alternative process 500 of determining the target routing area and re-directing the services to the target routing area. In block 502, the alternative network controller 106 selects a proximate target routing area, which is proximate to the target routing area 108, in addition to the target routing area 108. The proximate target routing area in this example is the second secondary routing area 110. In block 504, the primary communication network 102 re-directs services originally directed to the primary identification of the communication device 122 to the target routing area 108. In addition, the alternative network controller 106 also re-directs the services to the proximate target routing area 110. The alternative network controller 106 may also identify available secondary communication networks 112, 114, 116, 118, and 120 associated with the target routing area 108 and the proximate target routing area 110. In block 506, the alternative network controller 106 causes the available secondary communication networks 112, 114, 116, 118, and 120 to page the communication device 122.

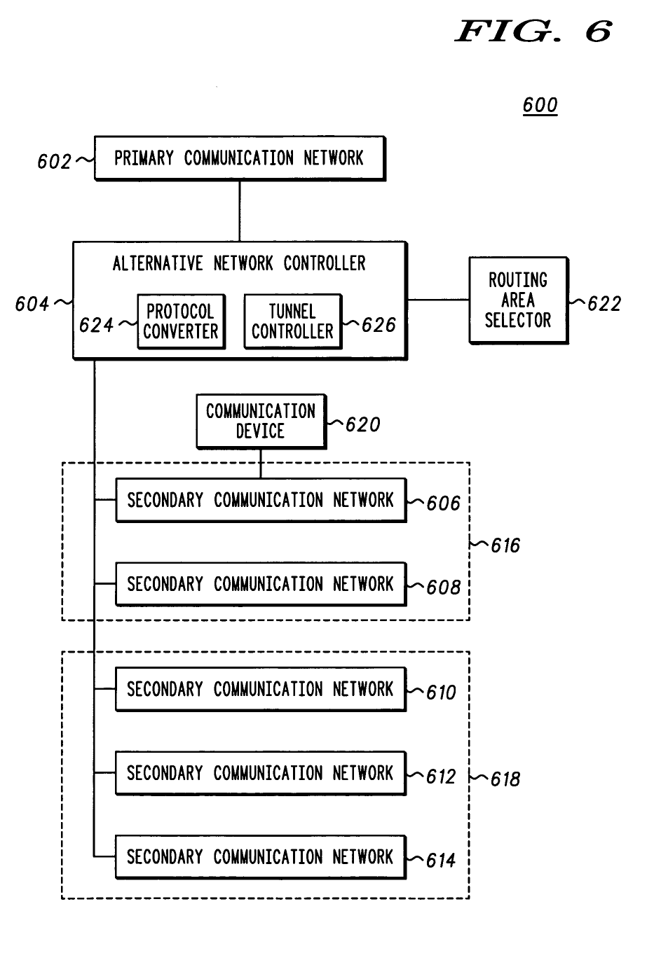

FIG. 6 is an exemplary block diagram of an embodiment in accordance with the present invention of a communication system 600 configured to select an appropriate routing area. The communication system 600 comprises a primary communication network 602, which has a primary routing area and is configured to support a primary cellular core network signaling protocol. An alternative network controller 604 is coupled to the primary communication network 602. The alternative network controller 604 is configured to communicate with the primary communication network 602 using the primary cellular core network signaling protocol. A plurality of secondary communication networks (only five secondary communication networks, 606, 608, 610, 612, and 614 are shown) are coupled to the alternative network controller 604. Each of the plurality of secondary communication networks is configured to support a secondary communication network protocol. The plurality of secondary communication networks, 606, 608, 610, 612, and 614 are grouped into a plurality of secondary routing areas (only two secondary routing areas, 616 and 618, are shown) with each secondary routing area having at least one secondary communication network. A communication device 620 is coupled to a particular secondary communication network, which is shown in FIG. 6 as the secondary communication network 606. The communication device 620 has a primary identification and is configured to support the primary cellular core network signaling protocol and the secondary communication network protocol. A routing area selector 622 is coupled to the alternative network controller 604, and is configured to identify a target routing area having the particular secondary communication network. In FIG. 6, the particular secondary communication network is shown to be the secondary communication network 606, making the target routing area to be the secondary routing area 616. The alternative network controller 604 is further configured to direct services initially directed to the primary identification of the communication device 620 to the target routing area 616 and to establish communication between the primary communication network 602 and the communication device 620 through the alternative network controller 604. To establish communication between the communication device 620 and the primary communication network 602, the alternative network controller 604 may utilize a protocol converter 624, which is configured to convert the primary cellular communication core network signaling protocol into the secondary communication network protocol, and to convert the secondary communication network protocol into the primary cellular core network signaling protocols. The alternative network controller 604 additionally has a tunnel controller 626, which is configured to set up, maintain, and control a tunnel between the communication device 620 and the alternative network controller 604.

The routing area selector 622 may be further configured to identify available secondary communication networks associated with the target routing area 616, and the alternative network controller 604 may be further configured to cause the available secondary communication networks 606 and 608 associated with the target routing area 616 to page the communication device 620. Additionally, the routing area selector 622 may be configured to determine a proximate target routing area proximate to the target routing area 616 and to identify available secondary communication networks associated with the proximate target routing area. For example, if the secondary routing area 618 were located in proximity to the secondary routing area 616, which is the target routing area, then the routing area selector 622 would determine the secondary routing area 618 as the proximate target routing area, and would identify secondary communication networks 610, 612, and 614. The alternative network controller 604 may be further configured to cause the available secondary communication networks 606, 608, 610, 612, and 614 associated with the target routing area 616 and with the proximate target routing area 618 to page the communication device 620.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method in a communication system for selecting a routing area for establishing communication between a primary communication network having a primary routing area and a communication device through a secondary communication network, the communication device supporting a cellular core network signaling protocol of the primary communication network and having a primary identification, the method comprising:
creating a plurality of secondary routing areas, each of the plurality of secondary routing areas comprising at least one of a plurality of secondary communication networks, each of the plurality of secondary communication networks capable of providing a communication coverage for the communication device;
detecting a presence of the communication device through a particular secondary communication network of the plurality of secondary communication networks;
determining a target routing area of the plurality of secondary routing areas, the target routing area having the particular secondary communication network; and
re-directing services originally directed to the primary identification of the communication device in the primary communication network to the target routing area by the primary communication network.

2. The method of claim 1, wherein creating a plurality of secondary routing areas includes:
assigning the plurality of secondary routing areas to an alternative network controller, the alternative network controller capable of establishing communication between the primary communication network and the communication device in the target routing area through the alternative network controller.

3. The method of claim 2, wherein establishing communication between the primary communication network and the communication device in the target routing through the alternative network controller by the alternative network controller includes:
converting a protocol of the secondary communication network into the cellular core network signaling protocol of the primary communication network; and
converting the cellular core network signaling protocol of the primary communication network into the protocol of the secondary communication network.

4. The method of claim 2, wherein establishing communication between the primary communication network and the communication device in the target routing through the alternative network controller by the alternative network controller includes:
setting up a tunnel between the communication device and the alternative network controller; and
controlling the tunnel.

5. The method of claim 2, wherein detecting a presence of the communication device through a particular secondary communication network of the plurality of secondary communication networks includes:
receiving a request from the communication device to access a particular secondary communication network of the plurality of secondary communication network by the particular secondary communication network of the plurality of secondary communication networks;
assigning a secondary identification to the communication device in response to receiving the request; and
authorizing the communication device to access the particular secondary communication network of the plurality of secondary communication networks.

6. The method of claim 5, wherein determining a target routing area of the plurality of secondary routing areas, the target routing area having the particular secondary communication network includes:
receiving a secondary routing area identification of the target routing area by the primary communication network; and
receiving the secondary identification of the communication device by the primary communication network.

7. The method of claim 6, re-directing services originally directed to the primary identification of the communication device in the primary communication network to the target routing area by the primary communication network includes:
associating the primary identification of the communication device with the secondary identification of the communication device by the primary communication network; and
re-directing the services originally directed to the primary identification of the communication device to the secondary routing area identification of the target routing area.

8. The method of claim 7, wherein re-directing the services originally directed to the primary identification of the communication device to the secondary routing area identification of the target routing area by the primary communication network includes:
identifying available secondary communication networks associated with the target routing area; and
causing the available secondary communication networks associated with the target routing area to page the communication device.

9. The method of claim 6, wherein determining a target routing area of the plurality of secondary routing areas, the target routing area having the particular secondary communication network further comprises:
determining by the alternative network controller a secondary routing area identification of a proximate target routing area proximate to the target routing area based upon the secondary routing area identification of the target routing area.

10. The method of claim 9, re-directing services originally directed to the primary identification of the communication device in the primary communication network to the target routing area by the primary communication network includes:
associating the primary identification of the communication device with the secondary identification of the communication device by the primary communication network; and
re-directing the services originally directed to the primary identification of the communication device to the secondary routing area identification of the target routing area and to the secondary routing area identification of the proximate target routing area.

11. The method of claim 10, wherein re-directing the services originally directed to the primary identification of the communication device to the secondary routing area identification of the target routing area and to the secondary routing area identification of the proximate target routing area by the primary communication network includes:
identifying available secondary communication networks associated with the target routing area and with the proximate target routing area; and
causing the available secondary communication networks associated with the target routing area and with the proximate target routing area to page the communication device.

12. A communication system configured to select an appropriate routing area, the communication system comprising:
a primary communication network configured to support a primary cellular core network signaling protocol, the primary communication network having a primary routing area;
an alternative network controller coupled to the primary communication network, the alternative network controller configured to communicate with the primary communication network using the primary cellular core network signaling protocol;
a plurality of secondary communication networks coupled to the alternative network controller, each of the plurality of secondary communication networks configured to support a secondary communication network protocol, the plurality of secondary communication networks grouped into a plurality of secondary routing areas, each of the plurality of secondary routing areas comprising at least one of the plurality of secondary communication networks;
a communication device coupled to a particular secondary communication network of the plurality of secondary communication networks, the communication device having a primary identification and configured to support the primary cellular core network signaling protocol and the secondary communication network protocol; and
a routing area selector coupled to the alternative network controller, the routing area selector configured to identify a target routing area having the particular secondary communication network,
wherein the alternative network controller is further configured to direct services initially directed to the primary identification of the communication device to the target routing area and to establish communication between the primary communication network and the communication device through the alternative network controller.

13. The communication system of claim 12, wherein the alternative network controller further comprises a protocol converter configured to convert the primary cellular communication core network signaling protocol into the secondary communication network protocol, and to convert the secondary communication network protocol into the primary cellular core network signaling protocols.

14. The communication system of claim 12, wherein the alternative network controller further comprises a tunnel controller configured to set up, maintain, and control a tunnel between the communication device and the alternative network controller.

15. The communication system of claim 12, wherein the routing area selector is further configured to identify available secondary communication networks associated with the target routing area.

16. The communication system of claim 15, wherein the alternative network controller is further configured to cause the available secondary communication networks associated with the target routing area to page the communication device.

17. The communication system of claim 15, wherein the routing area selector is further configured to determine a proximate target routing area proximate to the target routing area and to further identify available secondary communication networks associated with the proximate target routing area.

18. The communication system of claim 17, wherein the alternative network controller further configured to cause the available secondary communication networks associated with the target routing area and with the proximate target routing area to page the communication device.
